(19) United States
(12) Patent Application Publication
(10) Pub. No.: US 2014/0273834 A1
(43) Pub. Date: Sep. 18, 2014

(54) NEAR FIELD COMMUNICATION BASED SPATIAL ANCHOR AND BEACONLESS BEACON

(71) Applicant: OnlineSkillsCoach, Inc. dba KloudNation, Richardson, TX (US)

(72) Inventor: Bryan Merckling, Plano, TX (US)

(21) Appl. No.: 14/206,355

(22) Filed: Mar. 12, 2014

Related U.S. Application Data
(60) Provisional application No. 61/851,637, filed on Mar. 12, 2013.

(51) Int. Cl. H04B 5/00

(52) U.S. Cl. CPC H04B 5/0025
USPC 455/41.1

(57) ABSTRACT

A consumer may place a mobile device running an enabled application within a certain distance of an NFC spatial anchor and beacon that may first set the spatial anchor. The height and position of the mobile device may then be captured. An algorithm that combines accelerometer and gyro data may be used to continually track movement and angle shifts of the mobile device relative to the spatial anchor and a pre-mapped graphic, object and/or group of objects. While setting the spatial anchor, the anchor and beacon may provide metadata over NFC that may be used to generate an augmented reality experience. The mobile device may then generate a consumer experience that may augment or otherwise alter graphics or three-dimensional objects with a digital content overlay.

### CROSS-REFERENCE TO RELATED APPLICATION

This application claims the benefit of U.S. Provisional Application No. 61/851,637, entitled “NEAR FIELD COMMUNICATION BASED SPACIAL, ANCHOR AND METADATA BEACON,” filed Mar. 12, 2013, which is incorporated herein by reference in its entirety.

### FIELD OF THE DISCLOSURE

The present disclosure generally relates to spatial anchors and beacons, and more particularly to near field communication based spatial anchors and beacons.

### BACKGROUND

In the retail environment, approximately 70% of consumer purchase decisions are made in the store. However, the marketing messages that consumers typically receive within the store are not tailored to the individual consumer. Further, the marketing messages provided within the store are often not eye-catching such that the individual consumer may be compelled to further investigate and possibly purchase the product/service being marketed.

### SUMMARY

Embodiments of the present disclosure may provide a method for receiving one or more marketing messages via a near field communication (NFC) anchor and beacon system, the method comprising touching a mobile device to an NFC anchor and beacon, and receiving over a wireless communication network the one or more marketing messages based on the location and movement of the mobile device detected by the NFC anchor and beacon, the one or more marketing messages displayed on an application viewer on the mobile device, wherein the one or more marketing messages may include an augmented reality experience associated with the NFC anchor and beacon. The method also may comprise prompting a consumer to touch the mobile device to the NFC anchor and beacon. An application running on the mobile device may set spatial anchor coordinates, and the spatial anchor coordinates may comprise X, Y, and the height and direction that the mobile device is pointing. The method also may comprise responding to a request to opt in to receive the one or more messages. The one or more marketing messages may comprise one or more of the following: offers, loyalty points, augmented reality experience. The one or more marketing messages may be received immediately upon touching the mobile device to the NFC anchor and beacon. The one or more marketing messages may be received after the mobile device has touched more than one NFC anchor and beacon. The NFC anchor and beacon may be attached at a preset height to a display within a retail location.

Other embodiments of the present disclosure may provide a near field communication based spatial anchor and beaconless beacon system, the system comprising at least one NFC based spatial anchor and beaconless beacon positioned within a specified location, wherein the at least one NFC based spatial anchor and beaconless beacon may be programmed to pass height and direction information to an application running on a mobile device once the mobile device approaches the at least one NFC based spatial anchor and beaconless beacon, and wherein the at least one NFC based spatial anchor and beaconless beacon may transmit metadata relevant to the consumer experience to the mobile device over a wireless communication network. The at least one NFC based spatial anchor and beaconless beacon may be attached at a preset height to a display within the specified location. The mobile device may approach and touch the at least one NFC based spatial anchor and beaconless with the back of the mobile device. The metadata may comprise offers, product information and augmented reality experiences. The augmented reality experiences may comprise display of a two-dimensional or three-dimensional image describing a product within the specific location of the at least one NFC based spatial anchor and beaconless beacon, the display appearing on the mobile device. The system also may comprise a prompt displayed on the mobile device to purchase a product associated with the metadata upon viewing the metadata. An application on the mobile device may set spatial anchor coordinates comprising X, Y and the height and direction that the mobile device is pointing. The metadata may be transmitted when the mobile device approaches the at least one NFC based spatial anchor and beaconless beacon.

Further embodiments of the present disclosure may provide a method of managing a near field communication anchor and beaconless beacon system on a cloud-based dashboard, the method comprising registering one or more beacons associated with a specified location, defining one or more points of interest within the specified location, dragging the one or more beacons to the one or more points of interest on a graphical location map within the cloud-based dashboard, and connecting the one or more points of interest associated with the one or more beacons to a consumer experience, wherein when a mobile device approaches the one or more beacons, the mobile device may display the consumer experience. The consumer experience may comprise one or more of the following: offers, discounts, loyalty point bonuses, loyalty point redemptions, and augmented reality experiences. The method also may comprise via the cloud-based dashboard, reviewing movements and interest analytics tracked by the one or more beacons within the specified location. The method may further comprise managing the one or more beacons within the specified location, wherein managing comprises turning the one or more beacons on and off, adjusting location and ranges of the one or more beacons and editing the consumer experience associated with the one or more beacons.

### BRIEF DESCRIPTION OF THE DRAWINGS

For a more complete understanding of this disclosure, reference is now made to the following description, taken in conjunction with the accompanying drawings, in which:

FIG. 1 depicts an NFC anchor and beacon according to an embodiment of the present disclosure;

FIG. 2 depicts how an NFC anchor and beacon may be attached to a display within a retail location according to an embodiment of the present disclosure;

FIG. 3 depicts an augmented reality experience according to an embodiment of the present disclosure;

FIG. 4 depicts another augmented reality experience according to an embodiment of the present disclosure;

FIG. 5 depicts a process flow chart for a beaconless beacon system according to an embodiment of the present disclosure;

FIG. 6 depicts a process flow chart for managing a beaconless beacon system according to an embodiment of the present disclosure;

FIGS. 7A-7C depict examples of messages that may be provided to the consumer based on location and/or retailer-defined rules according to embodiments of the present disclosure;

FIG. 8 depicts a cloud-based dashboard for managing beacon actions according to an embodiment of the present disclosure;

FIG. 9 depicts an analytics screen on a cloud-based dashboard according to an embodiment of the present disclosure;

FIG. 10 management of beacons within a retail location using a cloud-based dashboard according to an embodiment of the present disclosure; and

FIG. 11 depicts a healthcare application according to an embodiment of the present disclosure.

### DETAILED DESCRIPTION

Embodiments of the present disclosure may provide near field communication (NFC) based spatial anchor and beaconless beacon systems and methods that may provide in-store marketing messages that may be tailored to an individual consumer. An individual consumer may receive marketing messages via his/her mobile device including an application that may communicate with one or more NFC anchors and beacons according to embodiments of the present disclosure. A provider/operator of an NFC anchor and beacon system may manage the system via a cloud-based dashboard or other tablet administration device according to embodiments of the present disclosure.

FIG. 1 depicts an NFC anchor and beacon according to an embodiment of the present disclosure. In an embodiment of the present disclosure, the NFC anchor and beacon may be approximately 0.5 inches in height, approximately 5 inches in length, and approximately 3 inches in width. However, it should be appreciated that an NFC anchor and beacon may be of any size and shape such that it may be positioned within a retail location. It also should be appreciated that NFC anchors and beacons may have different sizes and shapes even within the same retail location according to embodiments of the present disclosure. Accordingly, the size and shape may be adjusted to fit in, on or around certain places within the retail location.

An NFC anchor and beacon may be attached to a display within a retail location, such as depicted in FIG. 2, according to an embodiment of the present disclosure. It should be appreciated that the NFC anchor and beacon may be attached to the display at a preset height according to an embodiment of the present disclosure. However, there may be embodiments of the present disclosure wherein the NFC anchor and beacon may be placed at a variable height without departing from the present disclosure. There also may be embodiments of the present disclosure wherein an NFC anchor and beacon may be positioned in other places within a retail location, such as on the floor, on a table, or on a shelf, without departing from the present disclosure.

When an interrogating device, such as a consumer's mobile device, approaches the NFC anchor and beacon, the NFC anchor and beacon may pass height and direction information to the interrogating device. It should be appreciated that the interrogating device may include an NFC chip, and NFC-enabled mobile devices may include but are not limited to Windows Phone 8, Blackberry and Google phones and tablet devices.

It should be appreciated that the operations described as being performed by a mobile device, an NFC anchor and beacon and/or a cloud-based dashboard may be implemented as software instructions encoded on a computer-readable medium, in hardware programmed or designed to perform the operations, or both. As an example, the operations may be implemented as computer-executable components or other software. The mobile device may include at least one processor, one or more computer-readable media, such as memory, and a display or application viewer. The at least one processor may be programmed to execute computer-executable instructions for communicating with one or more NFC anchor and beacon and a centralized computer system according to embodiments of the present disclosure. It should be appreciated that the instructions to allow communications may be performed by a single processor or by multiple processors or by a processor external to the interrogating device (e.g., by a cloud service).

The NFC anchor and beacon may then pass metadata relevant to the consumer experience to the interrogating device over a wireless communication network. Metadata may include but is not limited to offers, product information, and augmented reality experiences, as described in more detail below. It should be appreciated that the metadata may be passed to the interrogating device through various wireless communication networks, including but not limited to NFC and Wi-Fi. Similarly, the NFC anchor and beacon may receive updated metadata via wireless communication methods, including but not limited to Wi-Fi or NYC, without departing from the present disclosure.

FIG. 3 depicts an augmented reality experience according to an embodiment of the present disclosure. When a consumer nears an NFC anchor and beacon attached to a display, a consumer may be presented with a two-dimensional or three-dimensional image that may be viewable through an application viewer provided through the consumer's mobile device. The two-dimensional or three-dimensional image may describe a product being displayed. The image also may challenge or encourage the consumer to purchase the product. In FIG. 3, the image of the basketball player is only visible to the consumer through use of the application viewer on the consumer's mobile device. It should be appreciated that this image may only be viewable when the NYC anchor and beacon evaluates the positioning of the consumer's mobile device relative to the NFC anchor and beacon and determines through an anchor and spatial algorithm that the application viewer on the consumer's mobile device is appropriately aimed. It also should be appreciated that the application viewer within the consumer's mobile phone may provide an open view to physical objects. The augmented reality experience may be provided by combining or imposing digital content on and around the existing physical objects, such as the shoes that are positioned on the display relative to the NFC anchor and beacon.

FIG. 4 depicts another augmented reality experience according to an embodiment of the present disclosure. In this embodiment of the present disclosure, when a consumer views the display through the application viewer on his/her mobile device, the male graphic may appear to be speaking to the consumer about the shoes being displayed, and the male graphic may appear to be running. It should be appreciated that there may be some embodiments of the present disclosure wherein the two-dimensional or three-dimensional images provided as part of an augmented reality experience may include one or more of the following: sounds, speech, action, and changing colors, without departing from the present disclosure.

When a consumer views an augmented reality experience through the application viewer on his/her mobile device, it should be appreciated that additional features, such as a buy-now button, may be made visible through the application viewer. Accordingly, if the consumer is persuaded to purchase the product being advertised on his/her application viewer, then the consumer can elect to purchase the product using his/her mobile phone in some embodiments of the present disclosure. In other embodiments of the present disclosure, the consumer may be presented with other selections, such as an option to read more about the product, on the application viewer without departing from the present disclosure.

FIG. 5 depicts a process flow chart for a beaconless beacon system according to an embodiment of the present disclosure. While FIG. 5 depicts a number of steps in a beaconless beacon system according to an embodiment of the present disclosure, it should be appreciated that more or fewer steps may be included in the process flow chart without departing from the present disclosure.

In a first step, a consumer may be directed to touch the hack of his/her mobile device to the NFC anchor and beacon when he/she approaches the NFC anchor and beacon within a retail location. It should be appreciated that the application within the consumer's mobile device may provide a prompt for the consumer touch or tap his/her mobile device to the NFC anchor and beacon in some embodiments of the present disclosure. In other embodiments of the present disclosure, the consumer may be prompted by signage on or around the display where the NFC anchor and beacon has been placed directing the consumer to touch or tap his/her mobile device to the NFC anchor and beacon.

In a second step, an anchor-enabled mobile application provided through the retailer or any application that has integrated a Software Developer Kit (SDK) containing the API for the anchor-enabled mobile application may set the spatial anchor coordinates that may include X, Y, as well as the height and direction that the mobile device is pointing. This position may be referred to as augmented reality north (or AR-north). It should be appreciated that the SDK may be a standalone application or may be integrated into an existing TOS for a mobile application according to embodiments of the present disclosure. It also should be appreciated that a retailer may customize the mobile application to display offers, store information and loyalty points according to embodiments of the present disclosure.

In a third step, the consumer may be asked to download the mobile application if it has not already been loaded on his/her mobile device. The consumer also may be asked if he/she would like to opt in for personal messages and offers. It should be appreciated that augmented reality experiences may be available for viewing through the application viewer regardless whether a consumer opts in for personal messages and offers.

In a fourth step, once the anchor (or AR-north) has been set, movement of the consumer's mobile device may then be tracked using an algorithm that may track accelerometer readings against a virtual map of a retail location. As consumers interact with more NFC anchors, then more accurate triangulation may be provided. This may be considered a form of beaconless beacon tracking of a mobile device.

In a fifth step, special offers and augmented reality experiences may then be launched based on the location of the mobile device as well as business rules that may be established, by a retailer. It should be appreciated that business rules may include presenting an offer or augmented reality experience immediately upon NFC scan or special offers may be provided based on 2-3 scans of a mobile device in a retail location that together may provide a profile of the consumer's interests within, the retail location.

FIG. 6 depicts a process flow chart of managing a beaconless beacon system according to an embodiment of the present disclosure. In step 1, administrators at a central corporate office or a retail location may register 1 to N number of retail locations. Store numbers may be used to create unique store-specific IDs for each beacon within a retail location or trigger and each point of interest location in each retail location. In step 2, administrators at a central corporate office or at a retail location may register the beacons or triggers associated with the retail location. While embodiments of the present disclosure have focused on near field communication to provide beacon technology, it should be appreciated that a retailer may select other beacon technologies without departing from the present disclosure. Using a cloud-based dashboard or tablet administration application, an administrator may also create new beacons or search and find a beacon that the information associated with the beacon may be captured automatically.

In step 3, administrators at a central corporate office or at a retail location may define store-specific points of interest (POIs). In step 4, administrators then may create consumer experiences that may include special offers discounts, loyalty point bonuses, loyalty point redemption, and augmented reality. In step 5, administrators may then drag beacons to POIs on a graphical store map within the cloud-based dashboard and/or tablet administration application and connect the POI to an experience that may be selected from an experience library that may be available to the administrator within the dashboard or application. In this embodiment of the present disclosure, the administrator is not required to know what type of beacon or trigger is used even if technologies other than near field communication may be used.

In step 6, a retailer may lease use of one or more beacons within a retail location to brand partners. If brand partners are to access one or more beacons, this may be performed through a brand partner module where access may be managed based on factors including but not limited to day, time and location.

In step 7, as consumers enter the retail location, signage and/or push messages to the consumers' mobile devices may be provided, indicating any special offers and experiences may be available. Consumers may be instructed on how to download the mobile application (if they have not previously downloaded), and upon downloading the application, consumers may be provided with the ability to “opt in” to receive messages and offers through their mobile devices. In step 8, consumers who opt in to receive messages and offers may then be presented with one or more special offers, loyalty options and augmented reality experiences based on arrival in POI locations, engaging via near field communication and/or image recognition according to embodiments of the present disclosure.

In step 9, the beacon system may track the consumers' movements through the retail location, including locations where the consumers remain for extended periods of time, items that consumers engaged, and images that they review on the mobile application. In step 10, a retailer may review consumer shopping and consumer interest analytics via a cloud-based dashboard that may be accessible via a tablet administration application. While the process for managing a beaconless beacon system has been described as having multiple specified steps, it should be appreciated that some of the steps may be omitted or additional steps may be included within the management process without departing from the present disclosure.

Once a consumer has entered the retail location, local beacons placed within the retail location may direct one or more specific messages to the consumer's mobile device based on location and/or retailer-defined rules. Several examples of such messages are depicted in FIGS. 7A-7C.

For example, in FIG. 7A, in a retail location selling shoes, a consumer may receive a message on his/her mobile device stating that a discount is available if the consumer purchases a specific type of shoe within the retail location. If the consumer elects to redeem that offer, the message may include means to redeem the offer including but not limited to, a selection button (such as “get this offer” by clicking here) or a discount code according to embodiments of the present disclosure. It should be appreciated that this type of message may be triggered when the consumer enters the shoe section of the retail location, but there may be some embodiments of the present disclosure where the message may not be triggered until the beacon detects that the consumer has been within the shoe section for a specified period of time (such as 10 minutes), indicating that the consumer may be interested in purchasing shoes but may not know what he/she wishes to purchase.

In some embodiments of the present disclosure, as in FIG. 7B the consumer may receive an advertisement on his/her mobile device informing the consumer that an item within the vicinity of the consumer is on sale. In this embodiment depicted in FIG. 7B, the message may be triggered when the consumer approaches a section where the item is being displayed.

In other embodiments of the present disclosure, as depicted in FIG. 7C, the consumer may receive a message on his/her mobile device welcoming him/her to the retail location. The message may indicate the number of times that the consumer has entered the retail location over time, and in some embodiments of the present disclosure, the consumer may be offered a discount or loyalty points based on being a frequent shopper at the retail location. It should be appreciated that these are examples of the types of messages that a consumer may be provided once inside a retail location, and the messages that may be provided are not limited. It also should be appreciated that a retailer may adjust the number and type of messages that consumers receive based on creating rules set by adding trigger actions for each beacon without departing from the present disclosure.

It should be appreciated, that beacon actions may be managed through various mechanisms, including a cloud-based dashboard, such as that depicted in FIG. 8. While the cloud-based dashboard of FIG. 8 is depicted as being displayed on a mobile tablet, it should be appreciated that there may be embodiments of the present disclosure wherein the dashboard may be utilized on a mobile device, a laptop, a personal computer, or other computing devices without departing from the present disclosure. Using such a mechanism, rules associated with one or more beacons, along with other information about each beacon, may be managed. It also should be appreciated that a retailer may even offer beacon access to its brand partners in some embodiments of the present disclosure. As depicted in FIG. 8, each beacon within a retail location may be identified within the cloud-based dashboard, and information about the location of the beacon within the retail location may be provided along with the type of emissions that the beacon may be providing at any given time. Further, actions associated with each beacon may be displayed within the cloud-based dashboard. For example, in FIG. 8, beacon 20 may be set to provide one message to a consumer when he/she first approaches the area where the beacon is placed (such as the men's shoe department). Beacon 20 also may be set to provide another message to the potential consumer if he/she remains within the area where the beacon is placed after a specified period of time has elapsed. It should be appreciated that a plurality of messages may be associated with a single beacon without departing from the present disclosure. It also should be appreciated that there may be times where no messages may be set for a given beacon. FIG. 8 also provides that additional beacons may be placed within the retail location and managed through the cloud-based dashboard according to embodiments of the present disclosure.

Embodiments of the present disclosure also may provide a retailer with the option to manage analytics associated with the beacons using a mechanism such as a cloud-based dashboard. FIG. 9 depicts an analytics screen on a cloud-based dashboard according to an embodiment of the present disclosure. Using the analytics screen, a retailer (and its partners) may be able to see more than just traffic patterns for consumers within the retail location. Accordingly, the retailer may see what consumers are interested in at any given time. In FIG. 9, a retailer may view analytics concerning all beacons placed within the retail location (in this instance, a sporting goods store location in Plano, Tex.). The retailer may view analytics directed to the most visited areas of the retail location, the average amount of time that consumers spent in different areas of the retail location, and common routes that consumers take in traveling around the retail location. However, it should be appreciated that the analytics are not limited to these items depicted in FIG. 9, and the analytics may differ depending on the type of retail location or the interests of the retailer without departing from the present disclosure.

A retailer may manage the beacons within a retail location using a cloud-based dashboard such as depicted in FIG. 10 according to embodiments of the present disclosure. In this embodiment of the present disclosure, the retailer may be presented with a store map where each of the beacons positioned within the retail location may be depicted on the store map. The retailer may then selectively turn the beacons on and off, adjust locations/ranges of the beacons, and edit the actions of the beacons without having to physically be present within the retail location according to embodiments of the present disclosure.

In an embodiment of the present disclosure, a consumer may place a mobile device running an enabled application within a certain distance of an NFC spatial anchor and beacon that may first set the spatial anchor. A certain distance may be within approximately 4 centimeters of the spatial anchor; however, it should be appreciated that the distance may be larger or smaller without departing from the present disclosure. The height and position of the mobile device may then be captured. In this embodiment of the present disclosure, the consumer's mobile device may act as an interrogating device. An algorithm that combines accelerometer and gyro data may be used to continually track movement and angle shifts of the mobile device relative to the spatial anchor and a pre-mapped graphic, object and/or group of objects. While setting the spatial anchor, the anchor and beacon may provide metadata that may be used to generate an augmented reality experience. It should be appreciated that the metadata may be transmitted and received via NFC protocols that may be known to one of ordinary skill in the relevant art. Once the spatial anchor has been set and an exchange of metadata that may be used to generate an augmented reality experience has occurred, the interrogating mobile device may then generate a consumer experience that may augment or otherwise alter graphics or three-dimensional objects with a digital content overlay. It should be appreciated that regardless whether the augmenting content is accessed via NFC metadata exchange, over a URL via Wi-Fi or through in-application storage, the augmented content may be provided for optimizing digital content across consumers' mobile devices and Internet access based on available bandwidth and sources of bandwidth available to the consumer mobile application. Accordingly, printed graphics may appear to be morphing into a movie that is framed and anchored to a page. Additional or other appearances may include but are not limited to three-dimensional graphics appearing to be rising out of a printed graphic, a talking mannequin, floating “buy now” buttons around and within an in-store display. This may sometimes be referred to as mobile device-based “retail theater” in some embodiments of the present disclosure.

While embodiments of the present disclosure have been described in a retail context, it should be appreciated that systems and methods according to embodiments of the present disclosure may be extended to industries including but not limited to healthcare. For example, FIG. 11 depicts a healthcare application according to an embodiment of the present disclosure. In this embodiment, one or more beacons may be placed within a healthcare facility such that a user, such as a doctor or nurse, may be made aware of the patient who is in a given examination room. The user also may be presented within an option to authenticate himself/herself in order to access the patient's medical records through the application without departing from the present disclosure. As depicted in FIG. 11, the user also may be provided with information including, but not limited to, the examination room number, the patient name, the time of day, and the assigned physician according to embodiments of the present disclosure.

Although the present disclosure and its advantages have been described, in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for receiving one or more marketing messages via a near field communication (NFC) anchor and beacon system, the method comprising:
touching a mobile device to an NFC anchor and beacon; and
receiving over a wireless communication network the one or more marketing messages based on the location and movement of the mobile device detected by the NFC anchor and beacon, the one or more marketing messages displayed on an application viewer on the mobile device,
wherein the one or more marketing messages includes an augmented reality experience associated with the NFC anchor and beacon.

2. The method of claim 1 further comprising:
prompting a consumer to touch the mobile device to the NFC anchor and beacon.

3. The method of claim 1 wherein an application running on the mobile device sets spatial anchor coordinates, the spatial anchor coordinates comprising:
X, Y, and the height and direction that the mobile device is pointing.

4. The method of claim 1 further comprising:
responding to a request to opt in to receive the one or more messages.

5. The method of claim 1, the one or more marketing messages comprising one or more of the following:
offers, loyalty points, augmented reality experience.

6. The method of claim 1 wherein the one or more marketing messages are received immediately upon touching the mobile device to the NFC anchor and beacon.

7. The method of claim 1 wherein the one or more marketing messages are received after the mobile device has touched more than one NFC anchor and beacon.

8. The method of claim 1 wherein the NFC anchor and beacon is attached at a preset height to a display within a retail location.

9. A near field communication based spatial anchor and beaconless beacon system, the system comprising:
at least one NFC based spatial anchor and beaconless beacon positioned within a specified location,
wherein the at least one NFC based spatial anchor and beaconless beacon is programmed to pass height and direction information to an application running on a mobile device once the mobile device approaches the at least one NFC based spatial anchor and beaconless beacon, and
wherein the at least one NFC based spatial anchor and beaconless beacon transmits metadata relevant to the consumer experience to the mobile device over a wireless communication network.

10. The near field communication based spatial anchor and beaconless beacon system of claim 9 wherein the at least one NFC based spatial anchor and beaconless beacon is attached at a preset height to a display within the specified location.

11. The near field communication based spatial anchor and beaconless beacon system of claim 9 wherein the mobile device approaches and touches the at least one NFC based spatial anchor and beaconless with the back of the mobile device.

12. The near field communication based spatial anchor and beaconless beacon system of claim 9, the metadata comprising:
offers, product information and augmented reality experiences.

13. The near field communication based spatial anchor and beaconless beacon system of claim 12 wherein the augmented reality experiences comprise display of a two-dimensional or three-dimensional image describing a product within the specific location of the at least one NFC based spatial anchor and beaconless beacon, the display appearing on the mobile device.

14. The near field communication based spatial anchor and beacon less beacon system of claim 9 further comprising a prompt displayed on the mobile device to purchase a product associated with the metadata upon viewing the metadata.

15. The near field communication based spatial anchor and beaconless beacon system of claim 9 wherein an application on the mobile device sets spatial anchor coordinates comprising X, Y and the height and direction that the mobile device is pointing.

16. The near field communication based spatial anchor and beacon less beacon system of claim 9 wherein the metadata is transmitted when the mobile device approaches the at least one NFC based spatial anchor and beaconless beacon.

17. A method of managing a near field communication anchor and beaconless beacon system on a cloud-based dashboard, the method comprising:
registering one or more beacons associated with a specified location;
defining one or more points of interest within the specified location;
dragging the one or more beacons to the one or more points of interest on a graphical location nap within the cloud-based dashboard; and
connecting the one or more points of interest associated with the one or more beacons to a consumer experience, wherein when a mobile device approaches the one or more beacons, the mobile device displays the consumer experience.

18. The method of claim 17, wherein the consumer experience comprises one or more of the following:
offers, discounts, loyalty point bonuses, loyalty point redemptions, and augmented reality experiences.

19. The method of claim 17 further comprising:
via the cloud-based dashboard, reviewing movements and interest analytics tracked by the one or more beacons within the specified location.

20. The method of claim 17 further comprising:
managing the one or more beacons within the specified location, wherein managing comprises:
turning the one or more beacons on and off, adjusting location and ranges of the one or more beacons and editing the consumer experience associated with the one or more beacons.
